(19) United States
(12) Patent Application Publication
(10) Pub. No.: US 2024/0128732 A1
(43) Pub. Date: Apr. 18, 2024

(54) Improved Electrical Box and Device and Method of Using Same

(71) Applicants: Christopher Telman, Franklin, TN (US); Henry J. Telman, Grand Rapids, MI (US); Robert A. Lintzenich, Grand Rapids, OH (US)

(72) Inventors: Christopher Telman, Franklin, TN (US); Henry J. Telman, Grand Rapids, MI (US); Robert A. Lintzenich, Grand Rapids, OH (US)

(21) Appl. No.: 17/967,067

(22) Filed: Oct. 17, 2022

(51) Int. Cl. H02G 3/12; H01R 13/516; H01R 24/28; H01R 24/68; H01R 24/78; H02G 3/18

(52) U.S. Cl. CPC H02G 3/123; H01R 13/516; H01R 24/28; H01R 24/68; H01R 24/78; H02G 3/18

(57) ABSTRACT

A system for installing an electrical box and/or installing an electrical device in an electrical box that includes a quick connect connector to connect wires to an electrical device without attaching wires directly to the electrical device. An electrical device can be equipped with prongs that correspond to the various wires that need to be connected thereto so that the device can be plugged into the electrical connector. Alternate embodiments include magnets that join the electrical connector to the device allowing conductive contacts on the device and connector to complete a circuit. Still other embodiments include a hinged door or a back portion of the electrical box that is can be disengaged from the front portion as well as versions in which the connector is located on the outside of the electrical box.

### BACKGROUND OF THE INVENTION

### (a) Field of the Invention

The present invention is in the technical field of electrical devices. More particularly, the present invention is in the technical field of electrical boxes and receptacles.

### (b) Background Art

An electrical receptacle or device is a generic term for a device such as an outlet, a light switch, or other fixture such as a ceiling fan or light, that is installed in an electrical box and electrically connected to an electrical system such as one installed in a building such as a home, office, store and/or industrial facility. Typically, electricity runs from a source of electricity, i.e. a breaker box, to the outlet through a wire, frequently called a hot wire. When an electrical device is connected to a circuit breaker or fuse box, the electricity from the circuit breaker box flows through the hot wire into the electrical device. In the U.S. the electrical industry typically colors this wire as black in order to easily distinguish it from other wires. Secondary hot wires are typically red. Another wire, the neural wire, which is normally white, is used to conduct electricity from the electrical outlet back to the source of electricity. A separate ground wire, usually green, is attached to the electrical receptacle and then to a portion of the electrical box that allows electricity running through the ground wire to leave the circuit and travel into the ground.

The installation of electrical boxes and devices is usually accomplished during the rough-in phase of construction. During the rough-in phase, electrical boxes are placed at desired locations throughout the building and wires are run through the walls and into the electrical boxes. During the rough-in process, contractors also install gas lines, water lines, cable tv lines and ductwork for HVAC systems. The wall coverings are then laid over the exposed portions of the wall.

If an electrician needs to replace an installed electrical box, they have to remove the old electrical box from its fixed position inside a wall or other structure and remove the wires from the old electrical box. The wires and grommet have to be securely installed in the new electrical box before the rest of the project can be completed. A section of the back of the electrical box must be “knocked out” or removed to create a hole through which to insert wires. Then the wires from the building's electrical system are fed though the back of the new electrical box. Typically, the wires are also inserted into a grommet positioned inside the “knock out” or hole that pinches the wires and secures them in place. Next, the new electrical box is inserted and secured inside a hole cut into the wall. Finally, an electrical device such as an outlet or a switch is installed in the electrical box as described below.

After turning off the power, someone wanting to replace an electrical device installed in an electrical box, such as an outlet, first removes the face plate or cover that partially covers the electrical device, typically by disengaging screws that hold the cover in place. Next the user disengages or unscrews screws that hold the electrical device in place in an opening of the electrical box in which the electrical device is inserted. Once the electrical device is removed from the electrical box, the user disengages the screws that hold the wires in place on the outside of the electrical device and removes the wires. The same wires are connected to the new electrical device—typically the black or hot wire is connected to a set of brass or “gold” screws, the white or neutral wire is attached to the electrical device via steel or “silver” screws and the ground wire is connected to the electrical device using a green colored screw and then to the electrical outlet. The wires are wrapped around the shank of the screw, beneath the head of the screw, and then the screw is tightened into place to ensure a secure connection. The wires are each touching conductive metal in the electrical device that conducts electricity from the wires to the correct portions of the electrical device. The electrical device is then fastened in place in a front opening of the electrical box and a face plate is usually fastened in place over the device. Once the electricity is turned back on the electrical device is ready for use.

The current state of the art presents various problems for both professionals and nonprofessionals alike. When electricians first install electrical boxes into an unfinished building, the wires are inserted into the electrical box through a hole in the back of the box and a grommet positioned in that hole that pinches the wires and secures them in place inside the box. However, the wires are left unattached to anything else and are left hanging free. Other contractors performing work in the same building may accidentally pull on the wires pulling them completely free of the electrical box. Usually, the electrician is not called back to the work site until the sheet rock or other wall covers are installed. If the electrical wires from one or more electrical boxes have been pulled free, the electrician is left trying to find the wires inside the partially finished walls and may have to cut away sheetrock to rewire the electrical box. This process is both time consuming and expensive and can require other contractors to come back and perform additional work such as sheet rock repair.

In addition, both professionals and amateurs installing or replacing electrical boxes or devices within electrical boxes are exposed to the risk of electrocution every time they handle wires. There is a need in the field for an electrical box and electrical devices that decrease the amount of time people spend handling wires when installing and replacing these components.

Nonprofessionals in particular would benefit from an improved way of installing or replacing electrical boxes or devices. It is not uncommon for individuals to accidentally wire an electrical device incorrectly, increasing the chances of a fire. In addition, feeding wires into a knockout in the back of an electrical box, then wrapping wires around screws and tightening the screws in place before mounting the new electrical receptacle all require a level of manual dexterity that some people simply do not have. In addition, some electricians advise people to wrap electrical tape around the screws on the outside of an electrical device to decrease the chances of some portion of a wire will touch the wrong component, sparking a fire. Other electricians will advise against this practice as covering wires that will produce heat with something that does not conduct heat very well can also lead to fire. Replacing an electrical device within an existing electrical box appears to be a simple task, but carries with it serious risks if not performed correctly.

There are other fire hazards presented by the present state of the art that are not a result of inexperience. For example, over time and after being exposed to excessive heat, the insulation on the outside of the conductors inside a wire can become brittle and wear off. With repeated manipulation, brittle insulation has a higher chance of disengaging with the conductors in the wire leaving those conductors exposed. As discussed above, exposed portions of wires inside the electrical box can present a significant fire hazard.

It is therefore a goal of the disclosed apparatus and system to provide the general public as well as electricians an easier means of installing a new electrical box and/or new electrical device, such as switch, fan and/or light into a wall, floor or ceiling. Another goal of the disclosed apparatus and system is to provide a safer electrical box and/or electrical device, switch, light or fan by reducing the chance of incorrect installation. Still another goal of the present disclosure is to provide a method of installing an electrical device inside an electrical box that requires less expertise and manual dexterity than prior devices. Yet another goal of the present disclosure is to describe an improved method for securing electrical wires inside an electrical box. Further goals of the present invention will become apparent to those skilled in the art from reading the following summary of the invention and the detailed description of the embodiments described and illustrated herein.

### BRIEF SUMMARY OF THE INVENTION

The present disclosure relates to an improved electrical box as well as an improved electrical receptacle that is easier and safer to wire, install, repair or replace. Instead of the traditional knockouts that are present in most electrical boxes, the inventors have devised an electrical box with openings having flexible tabs positioned therein that help to hold the wires inserted therein in place. In some embodiments, the tabs are operably connected to springs that serve to provide force to push the flexible tabs into a closed position, such that they are covering most, if not all, of the opening that they are positioned next to or inside. Both variations of the tabs apply force or pressure to wires inserted into the openings in the electrical box. These tabs eliminate the need for a grommet or connector through which the wires can pass and that prevents the wires from being damaged by chafing against the wall of the electrical box through which they are passing. They also are easier to manipulate than grommets and connectors that are meant to be inserted into or adjacent to knockouts. The user need only push the tabs out of the way and insert the needed wires and then release the tabs to insert and secure the wires in place inside the electrical box. Other embodiments of the electrical box have one or more holes in the back of the electrical box through which wires can be inserted.

Once the wires have been inserted into the electrical box, the free ends of the wires, i.e. the conductors inside the wires, are inserted into an electrical connector. This connector features openings for each of the ground, hot and neutral wires that need to run to the electrical device. In this disclosure, the term phrase, an element features another structure means that the structure is attached to, included with, integrated into, is on or inside the stated element. Other embodiments of the electrical connector have 4, 6, 8 or any number of openings for any number of wires or connections. The connector also uses levers or clamps controlled by levers that can be manipulated to alternately secure and release the free ends of the wires. As a result, some embodiments of the electrical box secure inserted wires at two separate places, the point of entry into the box and the point at which the wires are connected—the electrical connector. This arrangement decreases the chances the wires are accidentally pulled out of the box.

Preferred embodiments include fittings that allow the electrical connector to be secured in place inside the electrical box. For example, some embodiments include posts that extend through a portion of the cavity defined by the electrical box and are connected to an inside surface of the electrical box. The electrical connector can be secured to these posts and positioned as desired inside the electrical box. In some embodiments, the electrical connector is installed near the rear of the electrical box and can be accessible through a hinged door or holes in the back wall of the box. Other embodiments of the electrical connector are secured to the front of the electrical box in much the same manner as an electrical device or face plate are.

The electrical device has been modified to facilitate removal and installation. Specifically, instead of screws featured on one or more surfaces of the electrical receptacle, the electrical receptacle has prongs that are electrically connected to the necessary conducting components in the electrical receptacle. For example, instead of the contact openings being electrically connected to metal tabs that are in contact with metal screws that hold conducting wires in place as in a traditional outlet, the contact openings are electrically connected to a set of prongs—each prong representing a separate wire—one for the hot wire, one for the neutral wire and one for the ground wire—as needed.

Preferred embodiments of the electrical connector include openings with associated levers that when raised, allow for the insertion of wires into the openings and when lowered, secure the wires in place using friction. Inside the electrical connector, the wires, once inserted, either contact one or more of the prongs inserted into other openings on the electrical connector or they contact conductive metals that are in contact with the prongs. Inserting the wires into place completes a circuit between each wire and its respective prong on the electrical receptacle.

Once the electrical connector is wired and secured in place, the user need only insert the plugs on the electrical receptacle into the corresponding holes or openings in the electrical connector thereby completing the connection between the wires and the electrical receptacle. The prongs on the electrical receptacle are shaped such that the user cannot connect the wires incorrectly. This arrangement allows the user to replace an electrical outlet, for example, by removing the face plate and the screws holding the electrical receptacle in place, then unplugging the old electrical receptacle from the electrical connector and plugging a new outlet in place of the old one.

Another embodiment of the electrical connector and electrical receptacle allows the two devices to be connected to each other without the prongs on the electrical receptacle and the complementary openings on the electrical connector. In these embodiments, the prongs on the electrical connector are replaced with conductors or wires or other structures that allow the transmission of electricity. Similarly, the electrical connector will feature complementary conductors or contacts that will come into contact with those on the electrical receptacle when the two pieces are joined together. Magnets on the electrical receptacle and the electrical connector will allow the two pieces to stay joined together. In addition, the magnets can be arranged such that repel each other if the two structures are not connected in the correct orientation.

Some embodiments of the electrical box feature a hinged door on the back of the electrical box such that the user can access the inside of the electrical box from the back of the box before it is installed in a floor, ceiling or wall. This configuration can simplify the user's connecting the wires to the electrical connector. The electrical connector can come pre-installed and attached to the electrical box making installation that much simpler.

Another embodiment of the electrical box includes a removable back portion of the housing that is the electrical box. The electrical box is a housing that is open at one end and closed at an opposing end (hereinafter “the back wall”). In the inventors' preferred embodiment and anticipated best mode, the electrical box has a removable section that includes the back wall. The two sections can be attached to each other using conventional snap-in or locking release tabs or other fasteners such as screws. The user can simply remove the back half of the electrical box, rather than opening a hinged door, as described above, to access the electrical connector into which the electrical receptacle plugs.

The disclosed system produces a more efficient and safer method of installing an electrical system. It decreases the amount of time that an installer spend manipulating wires while installing or exchanging an electrical device within an electrical box since someone can simply unplug and plug in a new electrical device. The disclosed electrical receptacle or device has no wires attached directly to it decreasing the chances of electrocution as well as making it easier to safely install. The electrical connector itself decreases installation time and makes impossible to wire an electrical device incorrectly.

The disclosed system also allows for installation of an electrical receptacle by a less experienced electrician since it only requires the electrician to plug wires into the electrical connector rather than wrapping them around portions of the electrical receptacle and screwing them down.

The system also allows for the replacement of a broken outlet switch or light switch safely and quickly by unplugging an old electrical receptacle and plugging in a new one. Moreover, an existing line can be repurposed quickly by unplugging one type of receptacle, such as an outlet and plugging in a different type of electrical receptacle such as a light switch.

These devices and the methods of using them are suitable for residential, commercial and industrial electrical systems and can be used in single or multi-outlet box arrangements.

These and other advantages of the present invention will be apparent to those of ordinary skill in the art from reading the following detailed description of the embodiments described and illustrated herein.

### BRIEF DESCRIPTION OF THE SEVERAL VIEWS OF THE DRAWINGS

FIG. 1 is perspective exploded view of a first embodiment of the system;

FIG. 2 is a cross-sectional view thereof;

FIG. 3 is a side perspective view thereof with a sidewall of the electrical box removed;

FIG. 4 is a rear perspective view thereof with the hinged door in the back wall of the electrical box open;

FIG. 5A is top plan view of a second embodiment of the inventive system;

FIG. 5B is a top plan view thereof;

FIG. 6A is an exploded view of a third embodiment of the inventive system;

FIG. 6B is a perspective view of the back surface of an electrical device thereof;

FIG. 7 is a side perspective view of a fourth embodiment of the inventive system;

FIG. 8 is a rear perspective view of a fifth embodiment of the inventive system; and

FIG. 9 is an exploded view of a sixth embodiment of the inventive system.

### DETAILED DESCRIPTION OF THE INVENTION

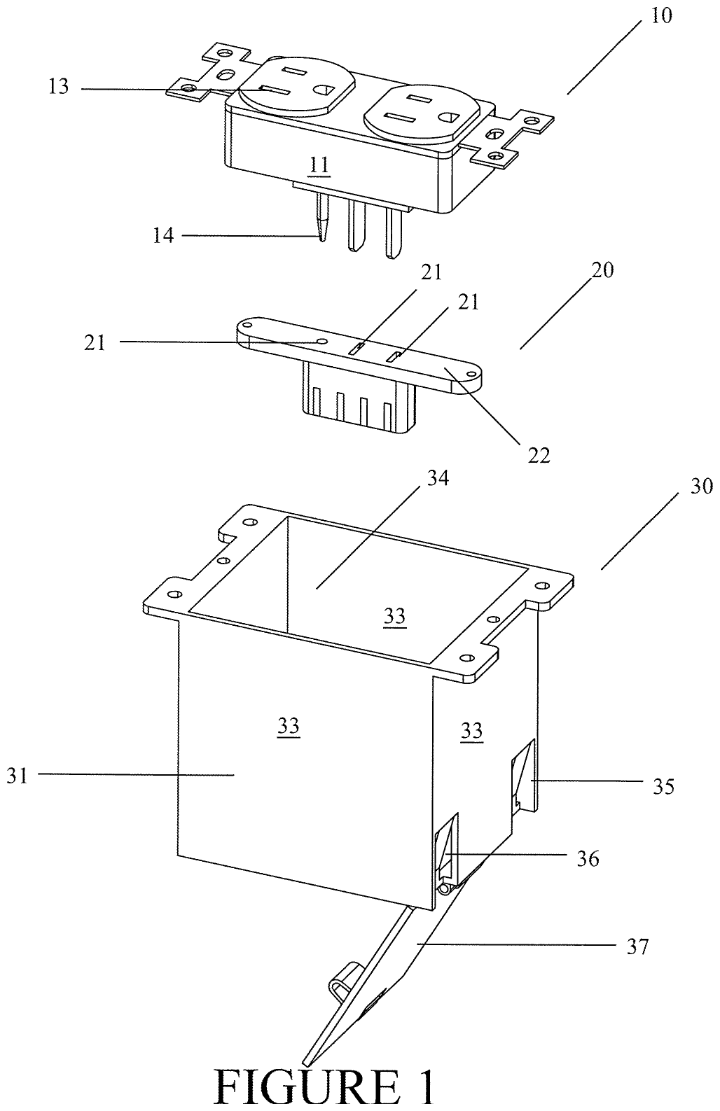

FIG. 1 shows the basic components of a first embodiment of the inventive system. FIG. 1 shows an example of an electrical device 10, in this case an outlet, the electrical connector 20 and the electrical box 30 that are discussed above. Typically, an electrical box 30 is a housing 31 with a closed end 32 and a front opening 34 directly opposed to the closed end 32. While this embodiment is generally square, electrical boxes in general come in a variety of sizes and shapes. Those sizes and shapes are not germane to this disclosure and for the purposes of illustration, the square electrical box will be used. Moreover, the disclosed electrical box need not have a closed end 32 at all, but may have two open ends 34 directly opposed to, i.e. facing each other. For the sake of simplicity, the embodiments below describe an electrical box with a single open end and a single closed end, but the other features of the disclosed system will also generally apply to an electrical box with two open ends joined by one or more sidewalls depending on the shape of the electrical box.

The electrical device 10 shown in FIG. 1 does not have the screws to which wires coming into the electrical box 30 are connected as is typical of prior devices, but rather, the electrical device 10 has a plurality of prongs 14 extending away from a body 11 of the electrical device 10. These prongs are operably connected¹, i.e. electrically, connected² to the contact openings 13 featured on the front surface of the electrical device 10 or more specifically, the conducting metal (not shown) inside the outlet that would normally form a circuit between the plug inserted into the contact openings 13 of the outlet and the screws to which wires are attached is connected to these prongs 14 such that electricity can flow between the prongs 14 and the conducting metal. In this embodiment, there are three uniquely shaped prongs 14—each for one of the wires or types of wires that need to be connected to the electrical receptacle. The three prongs 14 fit into complementary connector openings 21 in a front surface 22 of the electrical connector 20. Note that in FIG. 1, the prong 14 corresponding to the grounding wire is shaped differently than the other prongs 14 to make it easier to identify and impossible to insert into the wrong opening 21. The other prongs 14, including the prong 14 that connects the hot wire(s) can also be shaped or sized differently to make it impossible for a user to plug the prongs 14 into the incorrect openings 21 on the electrical connector 20. Other embodiments of the electrical connector 20 have 4, 6, 8 or any number of openings 21 for any number of wires or connections. When the prongs 14 are inserted into the complementary openings 21 featured by the electrical connector 20, the prongs are electrically connected to wire(s) (not shown) that are inserted into other openings in the electrical connector 20. Operably connected in this disclosure means that the two structures that are operably connected are connected in such a way that they work together. For example, the wires entering an electrical box are generally operably connected to an electrical device such that electricity flows to the electrical device.Electrically connected in this disclosure means that the two structures are connected such that electricity can flow from one structure to the other. For example, a light switch can be operably connected to a light bulb such that when the switch is flipped the light bulb turns off or on.

FIG. 1 also shows the electrical box 30. The electrical box 30 has a plurality of side walls 33 that form the housing 31. One or more of these side walls 33 contain openings 35 that are partially closed by flexible tabs 36 positioned to cover most or all of the openings 35. FIG. 1 also shows the hinged door 37 that makes up the back wall of the housing 31 in this embodiment. As discussed above, this hinged door 37 makes it easier for the user to access structures inside the electrical box 30.

FIG. 1 also shows how the structures fit together. The electrical box 30 has holes on a front surface near the opening 34 in the front of the electrical box 30 that can accept conventional fasteners such as screws. Such fasteners can be used to attach the electrical device 10 and the electrical connector 20 to the front of the housing 31 of the electrical box 30.

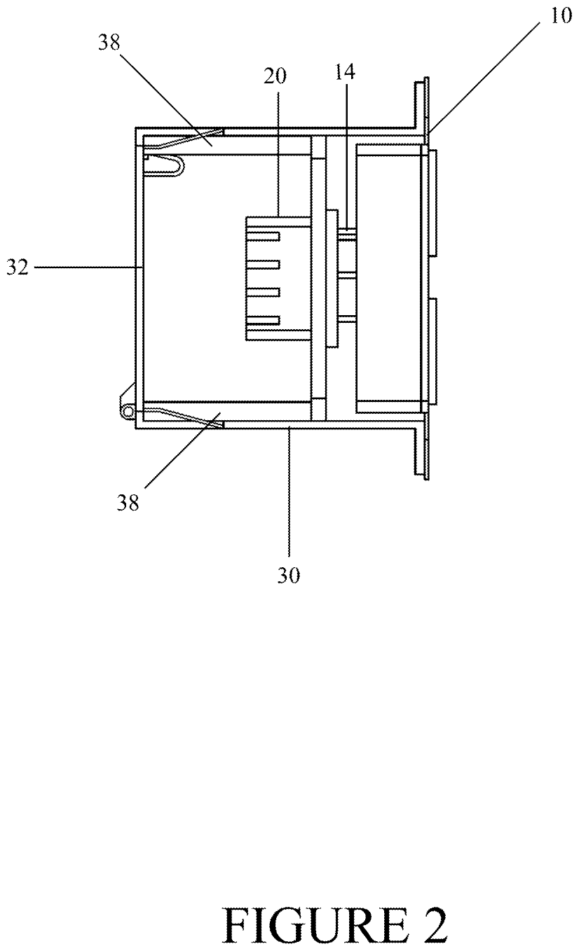

FIG. 2 is a cross sectional view of the electrical device 10, in the electrical box 30 and connected to the electrical connector 20. The hinged door 37 is closed in this figure. FIG. 2 shows the prongs 14 featured by the electrical device 10 having been at least partially inserted into the connector openings 21 on the electrical connector 20 without wires attached. This embodiment also features posts 38 extending along part of the length of the interior of the electrical box 30 that allow for the attachment of the electrical connector 20. These posts 38 are an alternate means of holding the electrical connector 20 in place. In these embodiments, the electrical connector 20 features openings through which the posts 38 can pass allowing the user to position the electrical connector 20 inside the electrical box 30 housing 31 by sliding the electrical connector 20 along the length(s) of the posts 38 thereby drawing the electrical connector 20 near or pushing it further away from the front opening 34 of the electrical box housing 31 where the electrical device 10 is positioned. This configuration allows the user to position the electrical connector 20 near the back wall or closed end 32 of the electrical box 30 if desired.

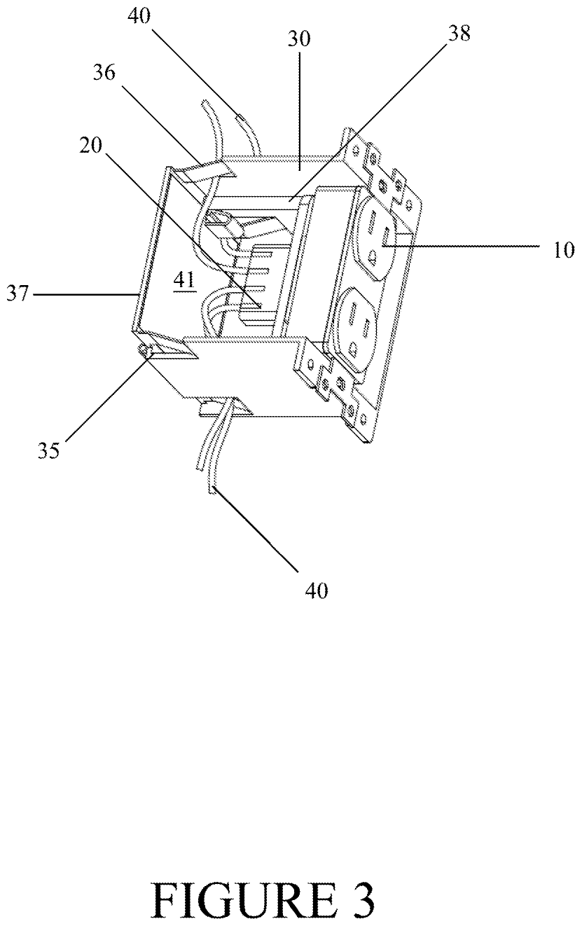

FIG. 3 shows an electrical device 10, an outlet, fully installed in an electrical box 30 using the inventive system. FIG. 3 shows wires 40 running to the electrical connector 20 by passing through the openings 35 in the electrical box 30, featuring flexible tabs 36, into the electrical box 30 and into the electrical connector 20 via a first set of openings 21. Once inserted through those openings, the tabs 36 hold the wires securely in place. The prongs 14 are not visible in this view as they are inserted into the electrical connector 20 as well. The electrical device 10 has been attached or fastened to the front of the electrical box 30 and the hinged door 37 that makes up the back wall 41 of the electrical box 30 has been closed. In this embodiment, the electrical connector 20 is attached to the posts 38 that run at least partially through the interior cavity of the electrical box 30. It is worth noting that some wires 40 enter the electrical box separately, i.e. the wires 40 are separated from each other prior to entering the electrical box 30.

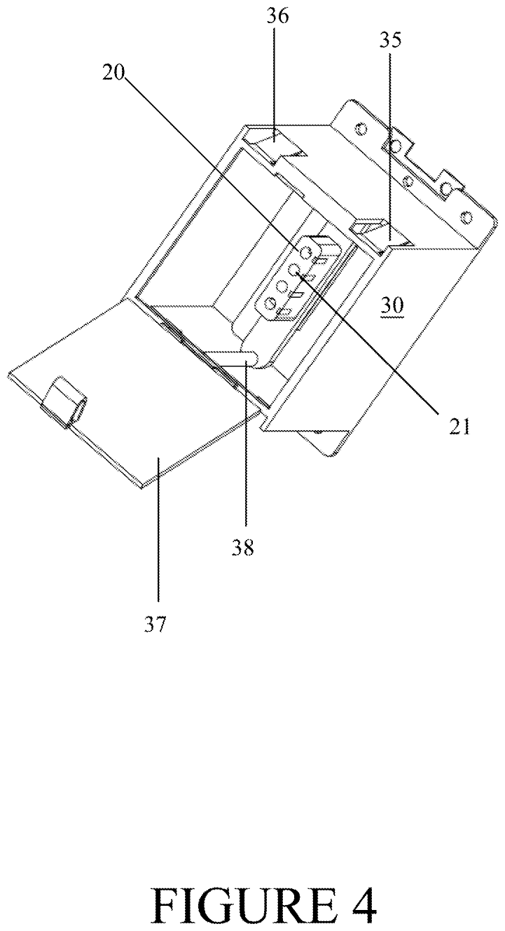

FIG. 4 shows the same embodiment of the disclosed system with the hinged door 37 open and the wires removed. The electrical connector 20 is visible as is at least one of the posts 38 upon which it is installed. The positioning of the posts 38 can be altered as long as they support the electrical connector 20 and hold it in place. The system will work without the electrical connector 20 being physically attached to structures inside the electrical box 30, but preferred embodiments have the connector 20 secured in place to make it simpler for someone to unplug an old electrical device and plug in a new one. Structures other than posts 38 can be used to secure the electrical connector 20 in place including tabs and slots, conventional fasteners and even adhesives. FIG. 4 also shows the flexible tabs 36 that guard the openings 35 in the housing or walls 33 of the electrical box. These tabs 36 can be pushed out of the way to insert wires into the electrical box 30.

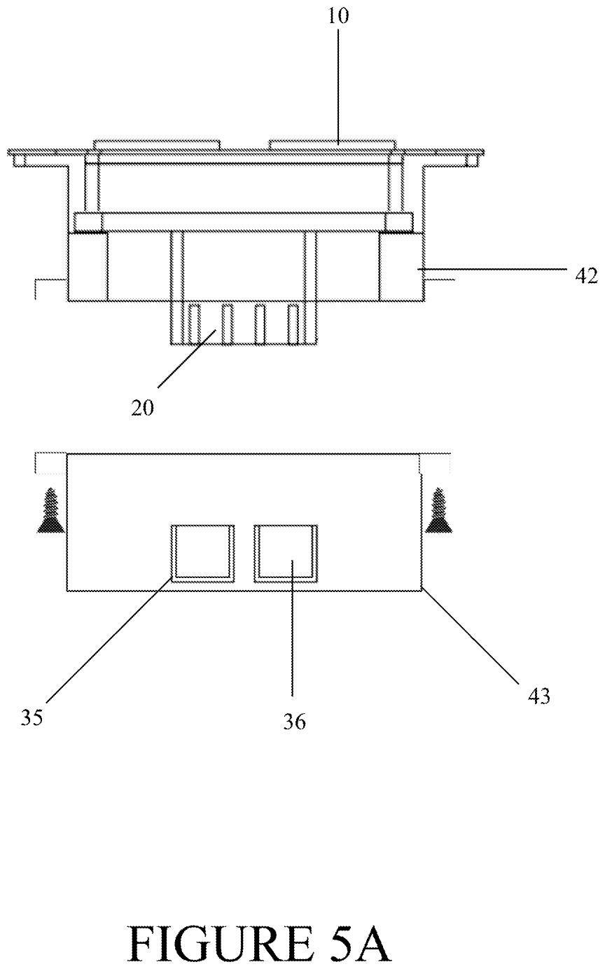

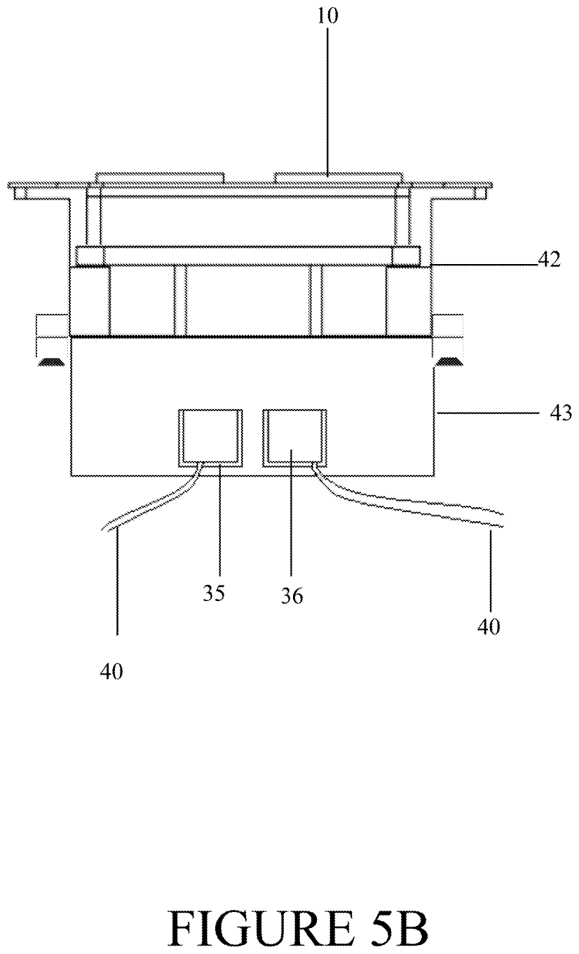

FIGS. 5A and 5B show a second embodiment of the inventive system. This system is substantially the same as the embodiment described above. However, in this embodiment, the electrical box 30 does not feature a hinged door that is directly opposite or opposing the front opening 34 of the electrical box 30, but rather a back portion 43 of the electrical box 30 can be disconnected from a front portion 42 of the electrical box 30 and reattached using conventional fasteners such as screws. In this arrangement, the electrical connector 20 is held in place by attaching it to structures that are inside the front portion of the electrical box 30. In this embodiment, the wires (not shown) are inserted into openings 35 in the back portion 43 of the electrical box 30 flanked or guarded by flexible tabs 36 located adjacent or proximate to the openings 35. After the user inserts the wires 40 into the openings 35, they can then attach conductors running through the wires 40 to the electrical connector 20 located in the front portion 42 of the electrical box 30. There is no specific or structural reason why the electrical connector 20 needs to be located in the front portion 42 of the electrical box 30, but rather it can be secured to the back portion 43 of the electrical box 30 and connected to the prongs on the electrical device 10 as the two halves or portions of the electrical box 30 are joined/fastened together.

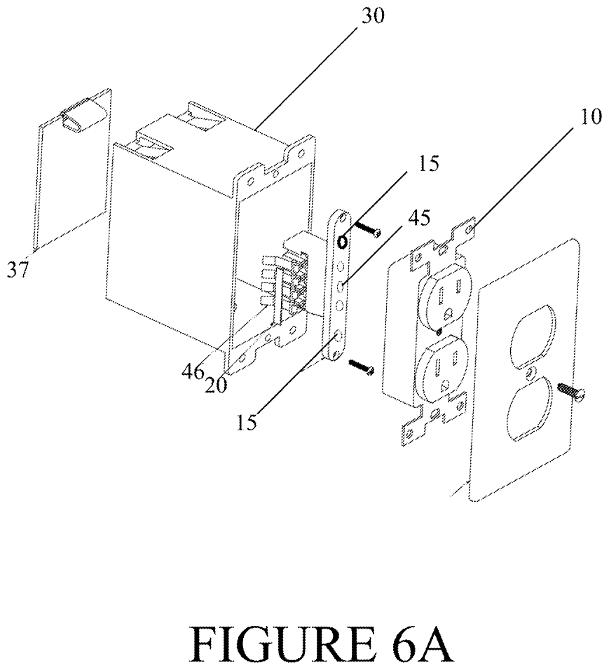

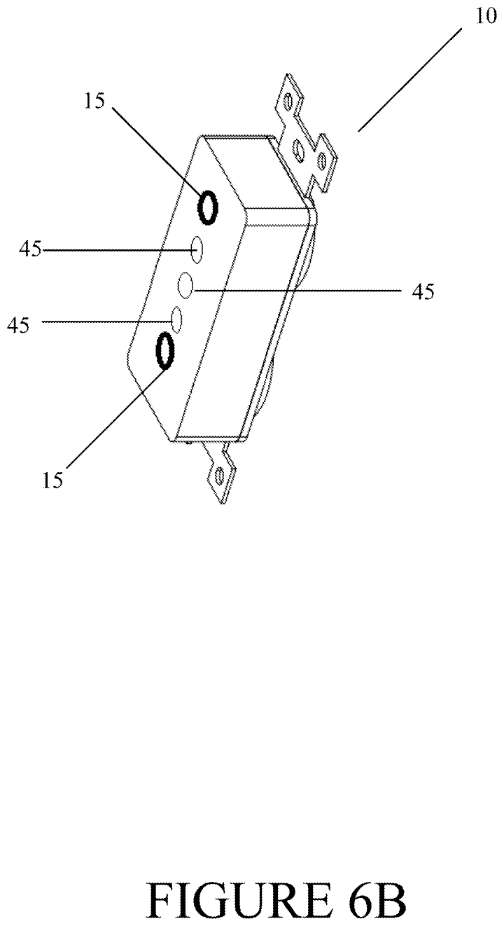

FIG. 6A shows an exploded view of a third embodiment of the presently disclosed system. This embodiment differs from those above in that it does not include the prongs 14 on a back surface 12 of the electrical device 10, but rather this embodiment uses magnets to join the connector 20 and the device 10 together. In some embodiments, an entire front surface 22 of the electrical connector 20 is magnetic and can attach to magnetic metal contained within or on the back surface 12 of the electrical device 10. In this embodiment, the front surface 22 of the electrical connector 20 may feature one or more magnets 15 that are attracted to magnets 15 of opposite polarity located on the back surface 12 of the electrical device 10 (see FIG. 6a) such that when the magnets 15 on the front surface of the electrical connector 20 are placed in close proximity to the back surface 12 of the electrical device 10, then the magnets on the connector 20 and device 10 are in contact with each other. In preferred embodiments and the anticipated best mode of the system, there is a first magnet 15 on the front surface 22 of the electrical connector 20 with a polarity that is opposite that of a second magnet 15 on the back surface 12 of the electrical device 10. Similarly, there can be a third magnet 15 on the front surface 22 of the electrical connector 20 and a fourth magnet 15 on the back surface of the electrical device 10 having opposite polarities. The magnets 15 on the front surface 12a of the electrical connector 20 are attracted to and bind reversibly with their complementarily positioned magnets 15 on the back surface 12 of the electrical device 10. This causes conductive contacts 45 on the front surface 22 of the electrical connector 20 to come into contact with conductive contacts (not shown) on the back surface of the electrical device 10 allowing electricity to flow from the electrical connector 20 to the electrical device 10. In some embodiments, the first and third magnets 15 on the electrical connector 20 have opposing polarities so that the user cannot connect the device 10 backwards, i.,e. connect the wrong conductive contacts 45.

FIG. 6 goes on to show additional features of this system. In this embodiment, the electrical connector 20 does not attach to posts 38 that run the length or at least part of the length of the interior of the electrical box 30, but rather, the electrical connector 20 has holes that traverse the electrical connector 20 such that it can be fastened in place using complementary holes on the front of the electrical box 30. Furthermore, FIG. 6 shows a variation of the electrical connector 20 that has levers 46 that can be manipulated to “open” and “close” the connector openings 21. When a lever 46 moves to an open position, a wire (not shown) can be inserted into the connector openings 21. When the lever 46 is in the “closed” position, the wire inserted therein is pinched or compressed by the lever 46 thereby holding it in place inside the connector 20.

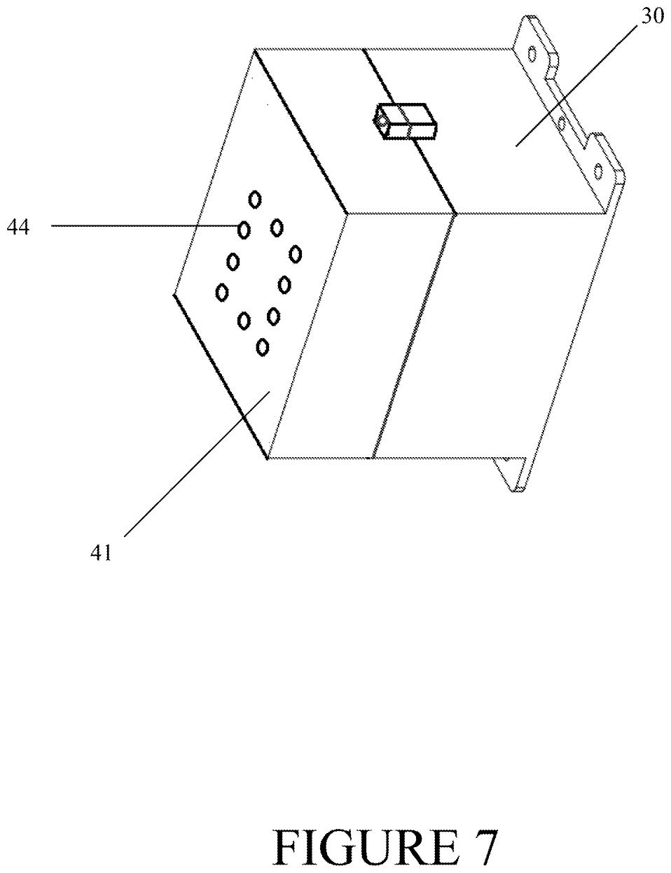

FIG. 7 shows a fourth embodiment of the disclosed system. Specifically, this embodiment eliminates the tabs 36 that are proximate to the openings 35 in earlier described versions of the electrical box 30. In this example, instead of four openings 35 located adjacent to or in the corners of the electrical box 30, there are a plurality of holes 44 located in the back wall 41 and/or the back portion 43 of the electrical box 30. In this embodiment, wires (not shown) are fed through these holes 44 without any structure pinching them in place at the point where they enter the electrical box 30. The wires will then pass into the connector openings (not shown) and will be held in place as described above.

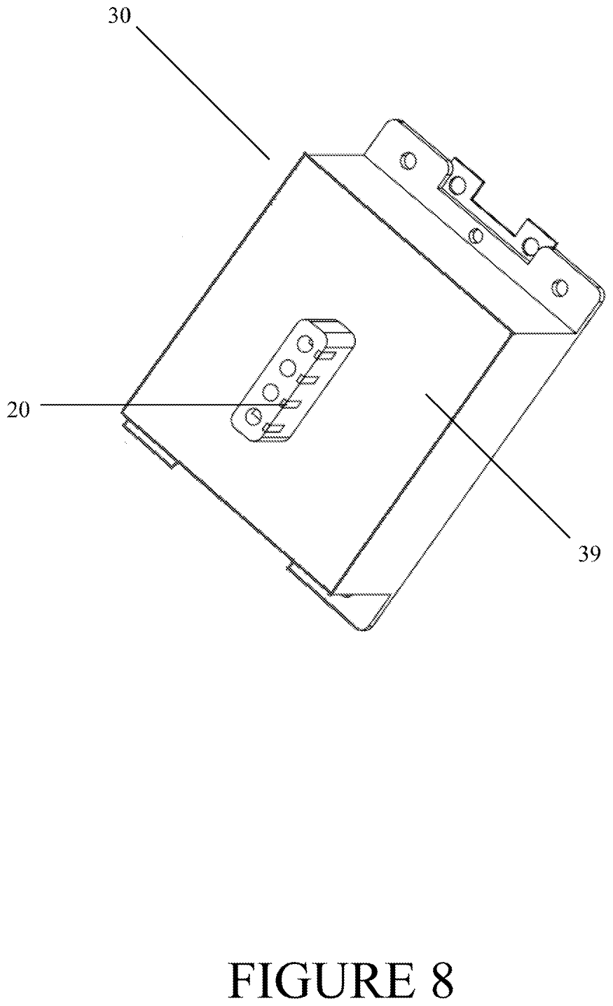

FIG. 8 shows a fifth embodiment of the disclosed system. In this embodiment, the electrical connector 20 is located on an outside surface 39 of the electrical box 30. These embodiments can be used with a shallower or smaller electrical box 30 to facilitate the connection between the electrical connector 20 and the electrical device 10. Additional spaced between the connector 20 that is accessible from the outside of the electrical box 30 and the electrical device 10 to which it connects could be traversed by additional wires or longer prongs 14, but these variations are less desirable. Because the electrical connector 20 is located on the outside of the electrical box 30, there is no need for wires to traverse a portion of the interior cavity (not shown) of the electrical box 30. This configuration decreases the amount of wiring inside the box decreasing the risk of fire from damaged wires or brittle insulation.

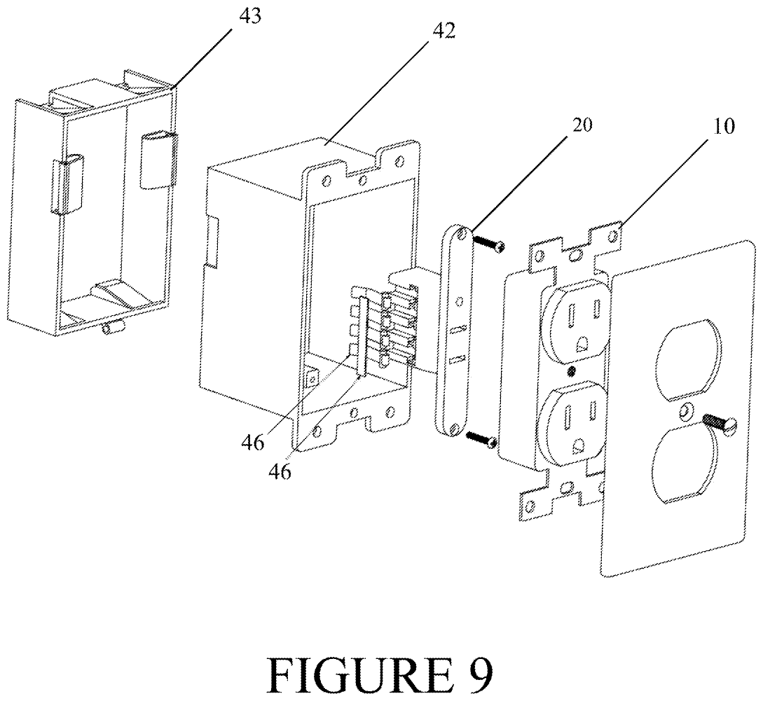

FIG. 9 shows an additional embodiment that combines some of the features previously discussed. It also shows how the various components of this system are connected. This embodiment of the system includes the electrical box 30 being divided into two sections—a front portion 42 and a back portion 43—that are attached to each other using clips, screws or other conventional fasteners. In addition, FIG. 8 shows the electrical connector attaching to a front surface of the electrical box 30 such that it is positioned inside the front opening 34 of the electrical box 30.

In broad embodiment, the present invention is a system for and method of replacing an electrical receptacle and/or an electrical box. The advantages of the present invention include, without limitation, the ability to “swap out” or easily replace an electrical receptacle or device quickly and easily. The system described above is safer to use in that it eliminates the use of conductive metal on the side of the electrical receptacle, thereby decreasing the chances of a short or a fire. The system also eliminates the need to use a grommet when inserting wires into the electrical box, thereby decreasing damage to the wires and their insulation over time. The system is also safer because it requires less handling of wires or conductors when installing the electrical device itself. Once the electrical box is installed, an inexperienced person can return to the construction site to finish installing the electrical devices/receptacles as they can simply be plugged into the electrical box that is already there. This system also decreases the chances that wires get pulled out of the electrical box and lost in the wall during the rough-in process. These and other advantages will be readily apparent to those of ordinary skill in the art based upon the above disclosure.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A system for installing an electrical device in a conventional electrical box having at least one first fastener opening, comprising:
an electrical connector having:
a first set of openings that can receive a plurality of wires;
a second set of openings in the connector that can receive a plurality of prongs such that when the plurality of wires and plurality of prongs are inserted into the first and second set of openings in the electrical connector, a circuit is made between the plurality of wires and the plurality of prongs; and
at least one second fastener opening positioned to align with the first fastener opening; and
an electrical device that is electrically connected to the plurality of prongs such that a circuit is made between the plurality of wires and the electrical device when the plurality of wires and plurality of prongs are inserted into the electrical connector; said electrical connector having at least one third fastener opening complementary to and positioned to align with the at least one second fastener opening and the at least one first fastener opening.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A system for installing an electrical device in an electrical box comprising:
an electrical connector positioned inside the electrical box with means to electrically connect a plurality of wires to the electrical device without attaching wires to the electrical device; and
at least one opening in the electrical device and at least one complementary opening in the electrical connector; wherein a single fastener inserted through the at least one opening in the electrical connector and the at least one opening in the electrical device and attaches the electrical connector and the electrical device to the electrical box.

18. The system of claim 17 wherein the means to connect a plurality of wires to the electrical device without attaching wires to the electrical device comprises:
a plurality of prongs electrically connected to the electrical device inserted into openings featured by the electrical connector such that the prongs are electrically connected to the plurality of wires.

19. (canceled)
